(19) United States
(12) Patent Application Publication
(10) Pub. No.: US 2016/0173739 A1
(43) Pub. Date: Jun. 16, 2016

(54) PORTABLE LAUNCH MONITOR

(71) Applicant: Acushnet Company, Fairhaven, MA (US)

(72) Inventors: Michael R. Madson, Waltham, MA (US); Edmund A. Hebert, Mattapoisett, MA (US); Chris Hixenbaugh, Dartmouth, MA (US); Nicholas M. Nardacci, Marion, MA (US); Richard Daprato, Acushnet, MA (US)

(73) Assignee: ACUSHNET COMPANY, Fairhaven, MA (US)

(21) Appl. No.: 14/568,215

(22) Filed: Dec. 12, 2014

(51) Int. Cl. H04N 5/225; H04N 5/232; G06K 9/00; A63B 24/00; H04N 7/18

(52) U.S. Cl. CPC H04N 5/2251; A63B 24/0021; H04N 7/18; G06K 9/00624; H04N 5/23296; A63B 2024/0034

(57) ABSTRACT

A launch monitor system and method for measuring flight characteristics of a golf ball are disclosed. The launch monitor system comprises a support structure, a smart device positioned to capture one or more images of the golf ball, a flash source, and an application configured to execute on the smart device. The software application processes images of the golf ball and determines one or more flight characteristics thereof.

### FIELD OF THE INVENTION

The present invention relates to a system that determines the flight characteristics of a golf ball using a smart device. The present invention also relates to a process for determining the flight characteristics of a golf ball using a smart device.

### BACKGROUND OF THE INVENTION

Apparatus for measuring golf ball flight characteristics are known. For example, U.S. Pat. No. 6,241,622 to Gobush et al. discloses a method and apparatus for measuring the speed, direction, and orientation of a golf ball and from such data computing the flight path of the ball.

Wireless mobile device systems that capture and display data related to golf shots are also known. For example, U.S. Patent Application Publication No. 2012/0088544 to Bentley et al. discloses a portable wireless mobile device motion capture data mining system and method configured to display motion capture/analysis data on a mobile device, and U.S. Patent Application Publication 2014/0300745 to Kirk et al., which discloses methods for determining a property of a trajectory of a ball with a mobile computer device. Also, according to pocketpro.org/howitworks.html, Pocket Pro Golf Designs' PocketPro device transfers golf swing data to an iOS device for analyzing a golfer's swing, including calculating the initial direction of the ball relative to the target line and its vertical angle off the ground based on the acceleration and rotation rate of a golf club.

However, there is no known portable, low-cost system that accurately determines the flight characteristics and predicts the trajectory of a golf ball based on images of the ball. Thus, the present invention provides such system.

### SUMMARY OF THE INVENTION

In one embodiment, the present invention is directed to a launch monitor system for measuring flight characteristics of a golf ball moving in a predetermined field-of-view. The launch monitor system comprises a support structure and a smart device secured thereto. The smart device has an onboard camera positioned to capture one or more images of the golf ball. The launch monitor systems also comprises an application configured to execute on the smart device, which processes the images and determines one or more flight characteristics of the golf ball, such as translation, rotation, initial velocity, backspin, side spin, rifle spin, and launch angle.

In another embodiment, the present invention is directed to a method for measuring flight characteristics of a golf ball moving in a predetermined field-of-view. The method comprises securing a smart device having an onboard camera to a support structure, positioning the support structure in a known location relative to the golf ball, executing an application on the smart device, capturing one or more images of the golf ball using the onboard camera and optionally a flash source, and processing the images of the golf ball using the software application to determine one or more flight characteristics of the golf ball, such as translation, rotation, initial velocity, backspin, side spin, rifle spin, and launch angle.

### BRIEF DESCRIPTION OF THE DRAWINGS

In the accompanying drawings which form a part of the specification and are to be read in conjunction therewith and in which like reference numerals are used to indicate like parts in the various views:

FIG. 1 is a perspective view of a peripheral camera and strobe device according to an embodiment of the present invention;

FIG. 2 is a perspective view of a support structure according to an embodiment of the present invention;

FIG. 3 is a perspective view of a support structure according to another embodiment of the present invention;

FIG. 4 is a perspective view of a support structure according to another embodiment of the present invention;

FIG. 5 is a perspective view of a support structure according to another embodiment of the present invention;

FIG. 6 is a perspective view of a support structure according to another embodiment of the present invention; and

FIG. 7 is a perspective view of a support structure according to another embodiment of the present invention.

### DETAILED DESCRIPTION

Portable launch monitors of the present invention are used to determine one or more flight characteristics of a golf ball by capturing and analyzing one or more images of the ball. The novel systems disclosed herein comprise a smart device, a support structure, and an optional external light source. For purposes of the present invention, the term “smart device” is used herein to mean an electronic device that is cordless when not being charged, easily transportable, readily connected to WiFi, 3G, 4G, etc., and is capable of data communication. Examples of suitable smart devices include, but are not limited to, smartphones, such as the Apple iPhone phones, Blackberry devices, Android-operated smartphones, and the Microsoft Windows phone; phablets, such as the Samsung Galaxy Note and Samsung Galaxy Player phablets, the LG Optimus Vu phablet, the Acer Iconia Smart phablet, and the Dell Streak phablet; and tablets, such as the Apple iPad tablets, the Samsung Galaxy Pad tablet, the Nook tablet, the Kindle Fire tablet, and the Blackberry Playbook tablet.

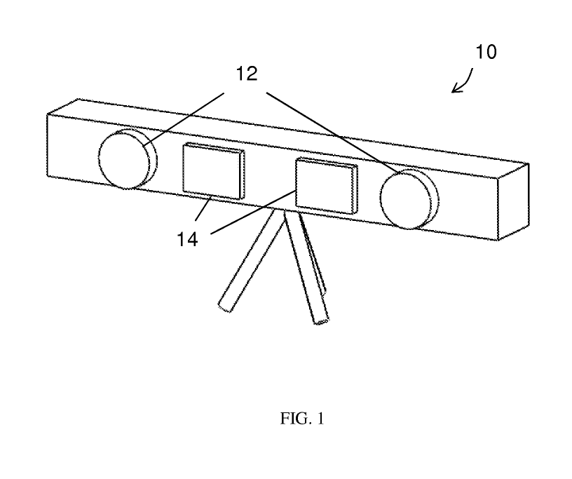

Suitable smart devices include an onboard camera capable of being activated using an auditory or visual trigger. In a particular embodiment, the camera is capable of strobe times from 10 microseconds to 0.01 seconds and flash times from 0.7 microseconds to 100 microseconds. In some embodiments, particularly embodiments wherein the camera of the smart device lacks ideal strobe and/or flash capabilities, an external flash or steady light source, such as a strobe peripheral device, and/or an external camera, are used to aid in capturing images of the golf ball. FIG. 1 illustrates a non-limiting example of a peripheral device 10 including two cameras 12 and two camera strobes 14.

Smart devices are equipped with an internal computer, including a processor that executes software modules, commonly known as applications. In smart devices of the present invention, a software application for processing and analyzing images is configured to execute thereon. As further discussed below, in one embodiment, the software application uses algorithms to calculate one or more flight characteristics of a golf ball based on images of the ball.

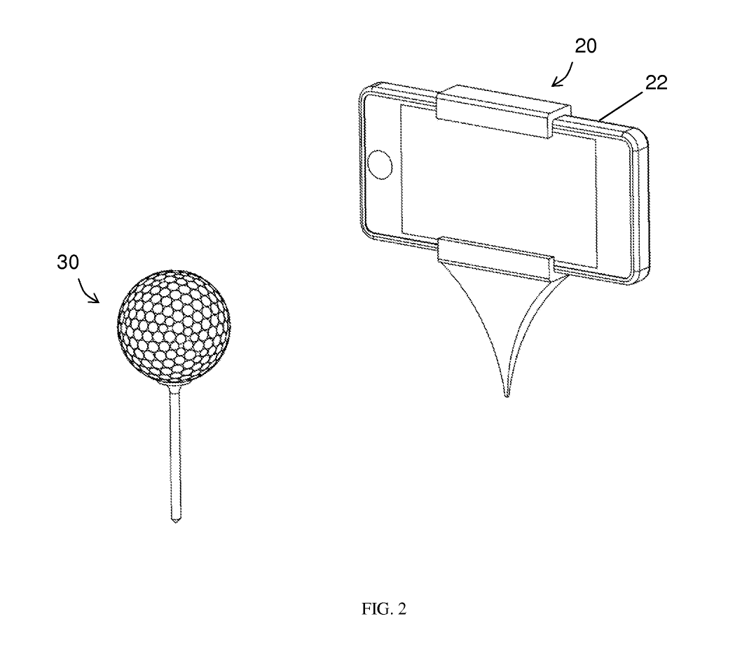

In order to keep the smart device stable during image acquisition and provide ideal positioning of the onboard camera relative to the golf ball and to the plane of the ground, a support structure can be used. FIG. 2 illustrates a non-limiting example of a support structure 20 with a smart device 22 secured thereto. Support structure 20 is teed into the ground at a distance from a golf ball 30. The distance from smart device 22 to golf ball 30 can be measured by hand, or the software application can be configured to calculate the distance using a distance algorithm assuming a known diameter of the golf ball. Support structure 20 optionally has a plurality of markings thereon to indicate the optimal height for capturing images of various types of golf shots, e.g., driver-type shots, wedge-type shots, etc. Smart device 22 may use two separate exposures, each with its own flash, or may flash twice during a single exposure, in order to acquire two images. Alternatively, smart device 22 can take a single exposure and a streak analysis can be used for computing flight characteristics.

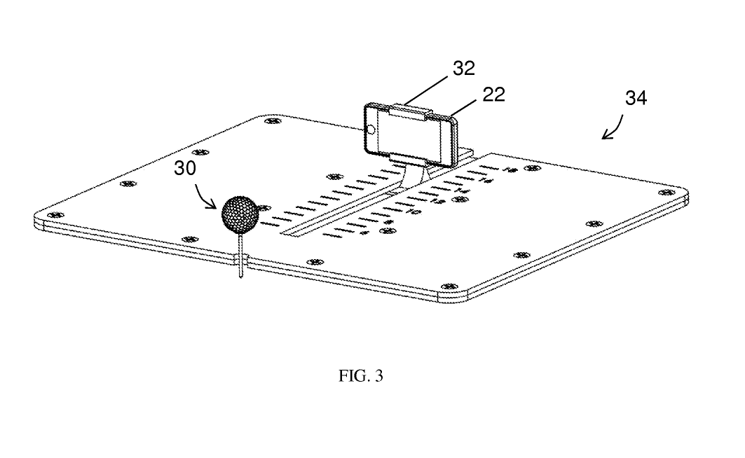

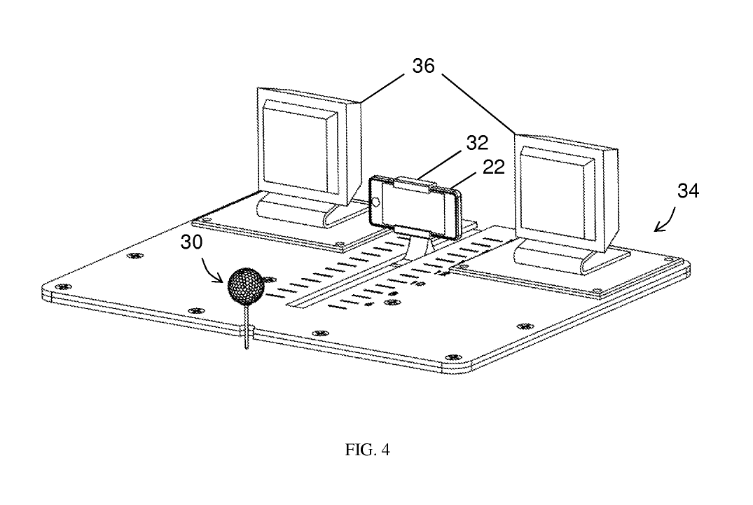

FIG. 3 illustrates a non-limiting example of a support structure 34 including an appendage 32 with a smart device 22 secured thereto. Golf ball 30 is located in a known location on or near support structure 34. Support structure 34 optionally includes markings such that appendage 32 can be moved to a position that is located at a known distance from golf ball 30. Alternatively, the software application can be configured to calculate the distance using a distance algorithm assuming a known diameter of the golf ball. In one embodiment, as shown in FIG. 4, support structure 34 may include one or more external flash sources 36 attached thereto, such that the flash of the smart device, if it is equipped with one, is not used.

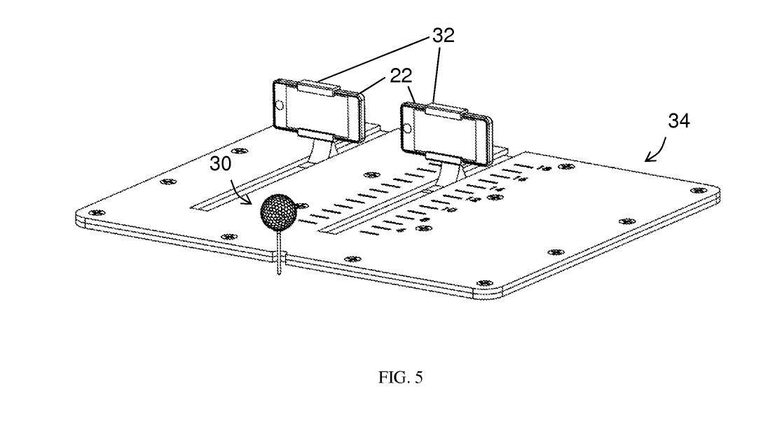

FIG. 5 illustrates a non-limiting example of a support structure 34 including multiple appendages 32 with smart devices 22 attached thereto. Each smart device is equipped to capture one or more images of golf ball 30, and, in a particular embodiment, the images are captured using a camera located on the same side of the smart device as the display screen. The smart devices can communicate with each other via hardwiring, Bluetooth, or other wireless methods, to determine the relationships between captured images.

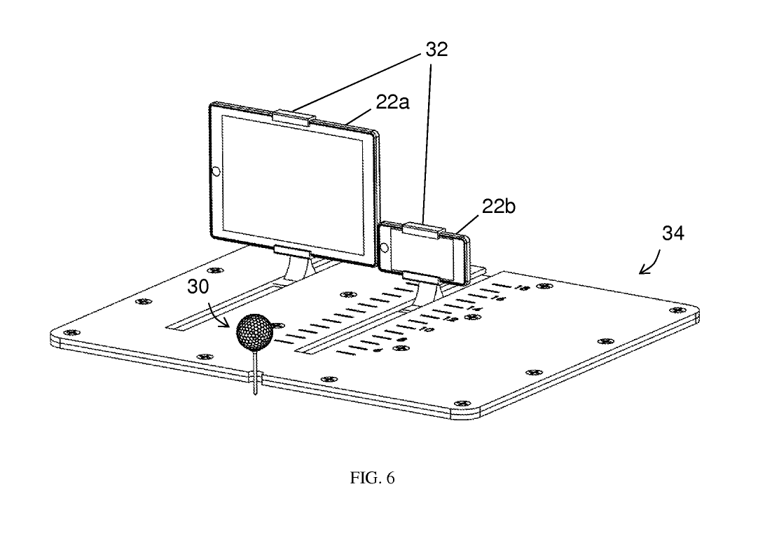

FIG. 6 illustrates a non-limiting example of a support structure 34 including multiple appendages 32 with a first smart device 22a and a second smart device 22b attached thereto. In a particular embodiment, first smart device 22a is a tablet-style smart device, and second smart device 22b is a smartphone-style smart device.

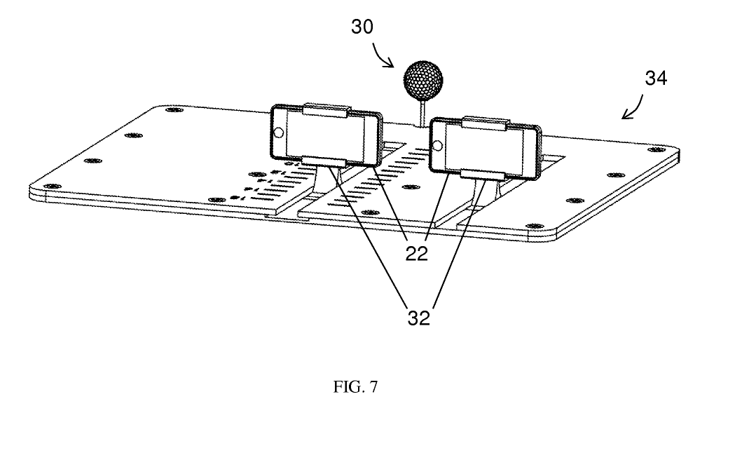

FIG. 7 illustrates a non-limiting example of a support structure 34 including multiple appendages 32 with smart devices 22 attached thereto. In a particular embodiment, images of golf ball 30 are captured using a camera located on the side of the smart device opposite the display screen.

Preferred methods for determining one or more flight characteristics of a golf ball using a portable launch monitor of the present invention comprise the following steps: connecting an optional external flash source and/or an optional external camera to a smart device, for example, by a Universal Serial Bus (USB), FireWire, Wi-Fi, Bluetooth technology, Lightning connector, or other similar data transfer means; executing a software application on the smart device; securing the smart device having an onboard camera to a support structure; positioning the support structure in a known location relative to a golf ball; capturing at least one image of the ball, one or more images being captured after striking the ball with a golf club; and processing the images using the software application to determine one or more flight characteristics of the ball.

The smart device is secured to the support structure and positioned in a known location relative to a golf ball. The golf ball should be oriented such that one or more markings, such as a sidestamp, nameplate, dots, or other marking suitable as a reference point for detecting rotation of the ball, are facing the camera. One or more photos are then taken, and the images of the golf ball captured therein are processed. Alternatively, one or more videos are taken, and the images of the golf ball captured in individual frames of the video are processed.

In a first embodiment, one photo is taken capturing a single image of the ball after being struck by the club and a streak analysis is used for computing flight characteristics.

In a second embodiment, at least two photos are taken, including a first photo capturing a still first image of the ball sitting on the tee, and a second photo capturing a second image of the ball after being struck by the club. The second photo is taken when an impact between the club and the ball is detected using an auditory or visual sensor of the smart device or peripheral device, including, but not limited to microphone or laser.

In a third embodiment, at least two photos are taken, including a first photo capturing a first image of the ball after being struck by the club at a first moment in time, and a second photo capturing a second image of the ball after being struck by the club at a second moment in time. The first photo is taken at the first moment in time when an impact between the club and the ball is detected using an auditory or visual sensor of the smart device or peripheral device. Immediately after acquisition of the first photo is complete, the second photo is taken at the second moment in time. In a particular aspect of this embodiment, photo capture and flash occur simultaneously, resulting in one photo taken during each flash. In another particular aspect of this embodiment, the shutter opens and closes multiple times during a single flash, resulting in two or more photos taken during a single flash.

In a fourth embodiment, a single photo capturing two or more images of the golf ball in different positions is taken by causing the camera strobe to flash multiple times while the camera shutter is open.

Flight characteristics of the golf ball, including, but not limited to, translation and rotation, are then measured using the acquired images. First, a point is selected that repeats itself in each image. In one embodiment, the software application uses an edge detection method to calculate the center of mass of the ball in each image. In another embodiment, a midpoint of the reference marking, e.g., dots, sidestamp arrows, nameplate, and the like, is used to represent the center of the ball in each image.

Translation is then measured as the distance between the repeating points. In one embodiment, a three dimensional coordinate system is defined prior to acquiring images, and translation is recorded by determining the location of the ball with the coordinate system at two points in time. In another embodiment, translation is determined based on a relative measure to the assumed diameter of the ball.

Rotation is measured as the change in angle of a defined reference marking from one image to another. Non-limiting examples of reference markings are sidestamps, nameplates, rows of dimples, retro reflective stripes, retro reflective dots, hand drawn markings, custom printings, and the like.

Translation and rotation can then be used to calculate additional flight characteristics of the golf ball, including, but not limited to, initial velocity, backspin, side spin, rifle spin, elevation angle, azimuthal angle, and launch angle. Velocity can be determined using the translation and the amount of time between image acquisitions. Backspin can be determined using the rotation and the amount of time between image acquisitions. Launch angle can be determined using translation, specifically the change in distance down range, and the change in elevation between images.

A computer algorithm can then be used to compute the trajectory of the ball using the calculated flight characteristics, optionally taking into account atmospheric conditions. For each time increment, the forces on the golf ball at time T are interpolated and the velocity at time T+1 is calculated from the velocity of the golf ball and the forces on the golf ball at time T. The mean velocity and the Reynolds number during the time interval from time T to time T+1 are calculated. The mean forces are then interpolated and used to calculate the velocity at time T+1. The forces include the drag force, the lift due to the spin of the ball, and gravitational forces. Using the velocity at time T+1, the position at time T+1 is computed, and spin rate at time T+1 is then computed. The length of the time interval is preferably 0.1 seconds. This calculation is performed until the golf ball reaches the ground. The equations used to perform these calculations are further disclosed, for example, in U.S. Pat. No. 6,533,674, the entire disclosure of which is hereby incorporated herein by reference.

Atmospheric conditions, including, but not limited to, temperature, barometric pressure, humidity, wind speed, and wind direction, are optionally taken into account in the trajectory computation. In one embodiment, the software application uses a weather-related application installed on the smart device to determine atmospheric conditions. In another embodiment, the software application uses information from a website to determine atmospheric conditions. In another embodiment, the smart device is equipped with weather sensors that the software application uses to determine atmospheric conditions.

The flight characteristics and/or ball trajectory are then communicated to the user.

In addition to determining flight characteristics and trajectory of a golf ball, the process disclosed herein optionally includes one or more of the following steps: automatic identification of the golf ball type/model using image recognition of the side stamp, dimple pattern, etc., which may yield more accurate results based on the particular model's known aerodynamic performance properties; limiting the functionality of the system based on the brand of the ball; and providing an option for the user to upload data to one or more media networks, including, but not limited to, social media sites.

In one embodiment, the data generated in the processes disclosed herein are used in a virtual golf game, wherein the golf shots previously captured become the options from which a player can choose for shots on a virtual golf course.

In another embodiment, the data generated in the processes disclosed herein are communicated to a party other than the user for marketing and research and development purposes.

When numerical lower limits and numerical upper limits are set forth herein, it is contemplated that any combination of these values may be used.

All patents, publications, test procedures, and other references cited herein, including priority documents, are fully incorporated by reference to the extent such disclosure is not inconsistent with this invention and for all jurisdictions in which such incorporation is permitted.

While the illustrative embodiments of the invention have been described with particularity, it will be understood that various other modifications will be apparent to and can be readily made by those of ordinary skill in the art without departing from the spirit and scope of the invention. Accordingly, it is not intended that the scope of the claims appended hereto be limited to the examples and descriptions set forth herein, but rather that the claims be construed as encompassing all of the features of patentable novelty which reside in the present invention, including all features which would be treated as equivalents thereof by those of ordinary skill in the art to which the invention pertains.

What is claimed is:

1. A launch monitor system for measuring flight characteristics of a golf ball moving in a predetermined field-of-view, the system comprising:
a support structure;
a smart device secured to the support structure and having an onboard camera positioned to capture one or more images of the golf ball; and
an application configured to execute on the smart device;
wherein the software application processes the images and determines one or more flight characteristics of the golf ball selected from translation, rotation, initial velocity, backspin, side spin, rifle spin, and launch angle.

2. The launch monitor system of claim 1, wherein the system additionally comprises a flash source contained in the smart device.

3. The launch monitor system of claim 1, wherein the system additionally comprises a flash source located in a peripheral device.

4. The launch monitor system of claim 1, wherein the system additionally comprises a second smart device secured to the support structure.

5. The launch monitor system of claim 1, wherein the support structure is teed in the ground.

6. The launch monitor system of claim 1, wherein the support structure is placed on top of the ground.

7. The launch monitor system of claim 1, wherein the software application transmits one or more of the flight characteristics to a data store not located on the smart device.

8. The launch monitor system of claim 1, wherein the onboard camera is operable to shutter at least two times as the golf ball moves through the field-of-view.

9. The launch monitor system of claim 1, wherein the onboard camera is operable to shutter at least three times as the golf ball moves through the field-of-view.

10. A method for measuring flight characteristics of a golf ball moving in a predetermined field-of-view, the method comprising:
securing a smart device having an onboard camera to a support structure;
positioning the support structure in a known location relative to the golf ball;
executing an application on the smart device;
capturing one or more images of the golf ball using the onboard camera and optionally a flash source; and
processing the images of the golf ball using the software application to determine one or more flight characteristics of the golf ball selected from translation, rotation, initial velocity, backspin, side spin, rifle spin, and launch angle.

11. The method of claim 10, wherein one image of the golf ball is captured and processed to determine the flight characteristics of the golf ball.

12. The method of claim 10, wherein the method additionally comprises securing a second smart device having an onboard camera to the support structure.

13. The method of claim 10, wherein the method additionally comprises transmitting one or more of the flight characteristics to a data store not located on the smart device.

14. The method of claim 10, wherein the method additionally comprises identifying the golf ball model using image recognition.

15. The method of claim 14, wherein the method additionally comprises altering the functionality of the system based on the results of the identification of the golf ball model.
